(19) United States
(12) Patent Application Publication
(10) Pub. No.: US 2012/0073767 A1
(43) Pub. Date: Mar. 29, 2012

(54) Bug catcher

(76) Inventor: Michael V. Graziano, Queen Creek, AZ (US)

(21) Appl. No.: 13/200,154

(22) Filed: Sep. 19, 2011

Related U.S. Application Data
(60) Provisional application No. 61/403,570, filed on Sep. 17, 2010.

(51) Int. Cl. E06B 9/54

(52) U.S. Cl. 160/368.1

(57) ABSTRACT

The present invention provides a generally rectangular metal screen covering to cover the radiator of a vehicle to protect the radiator from insects and other flying debris from clogging or otherwise damaging the vehicle's radiator. The screen covering is designed to be mounted in front of the radiator and behind the grill inside the body of the vehicle. The size of the covering can be any of a variety of sizes to accommodate a wide range of vehicles, from small automobiles to large SUVs and trucks. To facilitate a secure attachment to an automobile's radiator, the Bug Catcher is outfitted with a series of holes to accommodate attachment to mounting brackets on each side of the covering.

### CLAIM OF PRIORITY

This patent application claims priority under 35 USC 119 (e) (1) from U.S. Provisional Patent Application Ser. No. 61/403,570 filed Sep. 17, 2010, of Arlene Graziano entitled, “Bug Catcher.”

### FIELD OF THE INVENTION

The present invention pertains to the field of vehicle protective devices, and more specifically to the field of vehicle radiator protection screen devices.

### BACKGROUND OF THE INVENTION

The prior art has put forth several designs for vehicle radiator protection screen devices. Among these are:

U.S. Pat. No. 4,178,034 to Theodor H. Mittendorf describes an insect protection apparatus for protecting moving vehicles from insects having a rigid frame, at least partially covered with a screen, to prevent the passage of insects therethrough. The frame has a bumper attaching system which may be rapidly attached to most vehicle bumpers and which allows the frame to be aligned in front of the vehicle.

U.S. Pat. No. 4,236,592 to John H. Ziegler describes a structure for protecting front surfaces of moving vehicles from insects and debris and modulating air flow through the vehicle radiator to control cooling efficiency, including an air deflector mounted on the leading edge of the vehicle to deflect air, airborne insects and debris upward and over the windshield.

U.S. Pat. No. 4,836,598 to Ronald D. Mastin describes a plurality of screen brackets for attaching a bug screen or winter screen to a bug shield.

None of these prior art references describe the present invention.

### SUMMARY OF THE INVENTION

It is an object of the present invention to provide a vehicle radiator protection screen device.

It is a further object of the present invention to provide a line of metal screen coverings for use with automobiles and other vehicles to cover the radiator of the vehicle to protect the radiator from insects and other flying debris from clogging or otherwise damaging the vehicle's radiator.

It is a still further object of the present invention to provide a metal screen covering to cover the front of the radiator of a vehicle which, covering is mounted between the front of the radiator and the grill of the vehicle.

### BRIEF DESCRIPTION OF THE DRAWINGS

FIG. 1 is an elevational angled perspective view of the device of the present invention.

FIG. 2 is an elevational angled perspective view of the device of the present invention as shown from the outside of a motor vehicle.

FIG. 3 shows the device of the present invention mounted on a radiator.

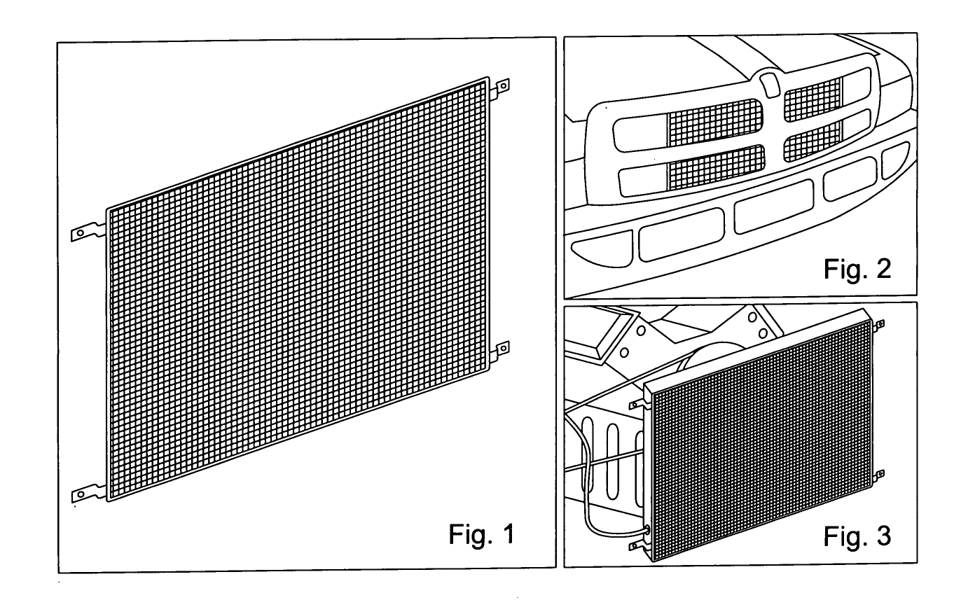

### DETAILED DESCRIPTION OF THE INVENTION

The present invention, hereinafter referred to as the Bug Catcher, or covering, comprises a generally rectangular metal screen covering to cover the radiator of a vehicle to protect the radiator from insects and other flying debris from clogging or otherwise damaging the vehicle's radiator. The screen covering is designed to be mounted in front of the radiator and behind the grill inside the body of the vehicle.

The device is generally rectangular in shape and fabricated of a metal screen material. The Bug Catcher is made of an ultra-fine mesh configuration with approximately 100 holes per square inch. The size of the covering can be any of a variety of sizes to accommodate a wide range of vehicles, from small automobiles to large SUVs and trucks. For example, a standard unit measures approximately twenty-nine inches in length, twenty-four inches in width, and four inches in depth. As noted, other embodiments are sized to accommodate virtually any model of vehicle. To facilitate a secure attachment to an automobile's radiator, the Bug Catcher is outfitted with a series of approximately five-sixteenth inch holes to accommodate attachment to mounting brackets on each side of the covering. The brackets are sized to accommodate the covering. For example, the mounting brackets may measure approximately one inch to three inches.

The Bug Catcher allows motorists to drive without worry of flying pests or other debris causing damage to their radiators. The present invention comprises a metal screen that is bolted on and fits tightly and securely in front of a car's radiator system, thus serving as a highly effective shield against a plethora of insects and debris, from larger annoyances such as bees to rocks and other flying road debris. The fine metal screen of the Bug Catcher easily repels these bugs and debris, without encumbering the radiator's operational capacity. As a result, the internal components of a vehicle are spared from damage, gas mileage and engine longevity is saved, as well as money.

Extremely easy to use, the Bug Catcher is attached in minimal time with basic hand tools. While ideal for keeping bugs out of the vehicle's radiator system, this versatile invention also serves as a protective barrier against flying debris such as dirt and rocks. As such, drivers do not have to worry about foreign matter flying into and damaging their radiators. Universal in application, the Bug Catcher is employed to cover radiators of vehicles ranging from autos, trucks and SUV's to 4×4's and RV's.

An innovative product invention, the Bug Catcher readily enhances the experience of driving without worry of bugs and foreign objects clogging the radiator system. Compact and lightweight, this product is a direct fit and ready to bolt on with basic hand tools. Affordably priced, the Bug Catcher is well received by owners and operators of motor vehicles, as well as campers, a sizable market potential.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vehicle radiator protection screen device, comprising:
a generally rectangular metal screen covering to cover the radiator of a vehicle to protect the radiator from insects and other flying debris from clogging or otherwise damaging the vehicle's radiator.

2. The device of claim 1 wherein the screen covering is designed to be mounted in front of the radiator and behind the grill inside the body of the vehicle.

3. The device of claim 2 wherein screen covering is and fabricated of a metal screen material.

4. The device of claim 3 wherein the metal screen material comprises an ultra-fine mesh configuration with approximately 100 holes per square inch.

5. The device of claim 3 sized to accommodate a wide range of vehicles, from small automobiles to large SUVs and trucks.

6. The device of claim 5 wherein the size measures approximately twenty-nine inches in length, twenty-four inches in width, and four inches in depth.

7. The device of claim 3, further comprising a series of holes to accommodate attachment to mounting brackets on each side of the covering.

8. The device of claim 7 wherein the holes are approximately five-sixteenth inch in diameter.

9. The device of claim 7, further comprising mounting brackets on each side of the covering.

10. The device of claim 9, wherein the length of the mounting brackets is sized to accommodate the covering.

11. The device of claim 10, wherein the mounting brackets measure approximately one inch to three inches in width.
